(19) United States
(12) Patent Application Publication
(10) Pub. No.: US 2020/0024503 A1
(43) Pub. Date: Jan. 23, 2020

(54) SURFACTANT ADDITIVE TO INCREASE RESIN PIPE BONDING

(71) Applicant: CSI Technologies LLC, Houston, TX (US)

(72) Inventors: Larry T. WATTERS, Spring, TX (US); Freddie L. Sabins, Spring, TX (US)

(21) Appl. No.: 16/212,971

(22) Filed: Dec. 7, 2018

Related U.S. Application Data
(60) Provisional application No. 62/700,730, filed on Jul. 19, 2018.

(51) Int. Cl. C09K 8/44; C04B 26/12; C04B 24/12; C04B 24/06; C04B 24/04; C04B 24/02; C04B 24/42; C04B 14/30; E21B 33/138; E21B 33/134

(52) U.S. Cl. CPC C09K 8/44; C04B 26/122; C04B 24/124; C04B 24/06; C04B 24/045; C04B 2103/14; C04B 24/42; C04B 14/30; C04B 14/308; E21B 33/138; E21B 33/134; C04B 24/02

(57) ABSTRACT

In an embodiment, a resin formulation is provided. The resin formulation includes a curable resin; a hardener, wherein a concentration of hardener is from 15 wt % to 80 wt % based on a total weight of the curable resin; and a surfactant, wherein a concentration of surfactant is from 0.1 wt % to 5 wt % based on the total weight of the curable resin. In another embodiment, a method of treating a wellbore is provided. The method includes adding to a subterranean wellbore a volume of a resin formulation, the resin formulation comprising a curable resin, a hardener, and a surfactant; and allowing the resin formulation to form a sealant.

### CROSS-REFERENCE TO RELATED APPLICATIONS

This application claims benefit of U.S. Provisional Patent Application No. 62/700,730, filed Jul. 19, 2018, the entirety of which is herein incorporated by reference.

### BACKGROUND

### Field

The present disclosure relates to the formulation of sealants, more particularly, to the formulation of sealants used to form sealing plugs, or to repair sealing plugs, in the bore or annuli of hydrocarbon and other wells extending inwardly of the earth and into hydrocarbon bearing formations therein. Embodiments hereof also relate to the application thereof in sealing a bore or annuli of hydrocarbon and other wells.

### Description of the Related Art

Hydrocarbon producing wells commonly consist of a series of telescoping steel pipes, known as casing, installed into a borehole extending inwardly from the earth's surface and to hydrocarbon bearing formations. Once a well is completed, regions of the annular space between the casings and the borehole, or between smaller diameter casings inside larger diameter casing, are typically sealed to prevent leakage of the hydrocarbons from within the casing into the earth at locations between a hydrocarbon producing formation and the earth's surface. For example, when the producing formation(s) has been penetrated by the well, a casing is run into the well, and a sealant is injected into the annulus between the casing and the earth typically continuously to a location at least several hundred feet above the producing formation. A production tubing is lowered into the well to fluidly connect the producing formation to the surface, and a production packer surrounds the production tubing and seals against the outer surface of the production tubing and the inner surface of the casing at a location above the producing formation, thereby sealing the area of the casing above the production packer from exposure to the producing formation, and to the fluids generated therefrom.

Well remedial operations or abandonment operations often require repair of a previously placed, but now failed, seal, or additional sealing of the annuluses, or setting of permanent sealing plugs within the inner volume of the casings, to prevent flow of hydrocarbons from below a sealing location upwardly through the seal and to the earth surface. Remedial operations and abandonment operations thus usually require setting sealant plugs within casing such as portions of hydrocarbon recovery conduits and the immediately adjacent annulus, as well as forcing fluid sealants into small openings in previously placed sealants and into small flow channels that may have formed therein over time. These sealing operations are performed using sealants that can be mixed and placed into the well tubings or pipes at the intended sealing locations therefor as fluids, which then harden into a solid seal after their placement. The sealant material must have mechanical properties sufficient to resist stresses imposed thereon by well fluids at or under pressure, withstand forces imposed on the conduit or pipe by mechanical operations for production, remediation or abandonment of the well, and maintain seal integrity during thermally-induced dimension changes of the conduits and pipes.

For both remedial and well plugging operations, as well as well construction operations, the sealant may be placed in an annulus between adjacent pipes or conduits, as well as within the inner circumference of one or more conduits. The annulus dimensions into which the sealant is pumped for well construction operations typically range from a 0.5-inch annular radius to a 3-inch annular radius (distance between outer wall of inner pipe and borehole and inner wall of outer pipe). Inner pipe diameters can range from 1¼ inches to 30 inches. Plugs to seal the interior of a pipe or borehole for remedial or abandonment operations can be required to have diameters ranging from 1 inch to 30 inches. Sealant lengths along the depth direction of the well in both the annulus and bore range from 10 feet to thousands of feet. Sealant application temperatures range from over 400° F. to less than 40° F. Some leaks or seal breaches require sealant placement into small openings ranging from leaks in threaded connections, to microannulusses formed between a casing-sealant interface, to permeation of a sand bed or formation with a sealant.

Resins (e.g., epoxy resins) are useful as well sealants for construction, remediation, and abandonment. However, epoxy resins exhibit several mechanical and performance properties that are detrimental to their functioning as well sealants. In general, the crosslinking reaction between epoxy and hardener can result in volume reduction of the mass of epoxy resin as it sets, i.e., the epoxy will shrink as it sets. This shrinkage can be exaggerated when using liquid diluents to increase the volume of the epoxy resin based sealant to lower the cost of the sealant per unit volume thereof, or to lower the viscosity of the epoxy resin based sealant for easier delivery thereof to the sealing location of the well. Epoxy resin generally shrinks slightly on curing to its set condition. The magnitude of shrinkage depends on the resin:hardener ratio, the presence and amount of diluents in the mixture, and whether additional setting reaction accelerators are used and the magnitude of the difference between the setting temperature and the ambient temperature of the sealing location in well. This shrinkage during cure or set can weaken the resulting seal, or result in seal failure, depending on the magnitude thereof.

Additionally, the strength of the bond (e.g., an adhesive bond) between the resin and the pipe or annulus is an important factor in addressing the durability of the seal. Special sealant problems for wells indicate a need for better formulations to improve resin-pipe bonding and resin-annulus bonding as well as methods for improving the bond at the resin-pipe interface and the bond at the resin-annulus interface.

### SUMMARY

A resin formulation is provided which is a curable resin that includes a surfactant. The resin formulation, once set, forms a sealant that exhibits improved bond strength between the resin and the pipe or annulus.

In an embodiment, a resin formulation is provided. The resin formulation includes a curable resin; a hardener, wherein a concentration of hardener is from 15 wt % to 80 wt % based on a total weight of the curable resin; and a surfactant, wherein a concentration of surfactant is from 0.1 wt % to 5 wt % based on the total weight of the curable resin.

In another embodiment, a resin formulation is provided. The resin formulation includes a curable resin; a surfactant, wherein a concentration of surfactant is from 0.1 wt % to 5 wt % based on a total weight of the curable resin; a diluent, wherein a concentration of diluent is from 5 wt % to 90 wt % based on the total weight of the curable resin; a hardener, wherein a concentration of hardener is from 15 wt % to 80 wt % based on the total weight of the curable resin; a silane, wherein a concentration of silane is from 0.5 wt % to 20 wt % based on the total weight of the curable resin; and an amount of weighting agent such that the resin formulation has a density of from 10.0 lb/gal to 20.0 lb/gal.

In another embodiment, a method of treating a wellbore is provided. The method includes adding to a subterranean wellbore a volume of a resin formulation, the resin formulation comprising a curable resin, a hardener, and a surfactant; and allowing the resin formulation to form a sealant.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1A is a schematic sectional view of an offshore well targeted for abandonment.

FIG. 1B is a schematic sectional view of the well of FIG. 1A with normal abandonment operations complete up to installation of the final plug at the top of the well.

FIG. 1C is a schematic sectional view of the well of FIG. 1B prepared to set a resin plug above the plug that has leaked.

FIG. 1D is a schematic sectional view of the well of FIG. 1C with the resin plug set in place.

### DETAILED DESCRIPTION

Herein is provided, a resin formulation, that once set or partially set, has an improved bond strength to a pipe or annulus. For annuluses, the resin can either bond to the pipe and/or bond to the formation (e.g., a rock formation). Alternatively, an annulus can consist of an inner pipe and outer pipe or a pipe inside a borehole in a formation. The resin sealant must bond to both inner and outer boundaries of an annulus. Resistance of the resin-pipe bond and resin-annulus bond to fluid and gas intrusion and loading is greatly improved.

This disclosure includes chemical structures that show atomic compositions of compounds and relative bonding arrangements of atoms in a chemical compound. Unless specifically stated, the geometric arrangement of atoms shown in the chemical structures is not intended to be an exact depiction of the geometric arrangement of every embodiment, and those skilled in the chemical arts will recognize that compounds may be similar to, or the same as, the illustrated compounds while having different molecular shapes or conformations. For example, the structures denoted herein may show bonds extending in one direction, while embodiments of the same compound may have the same bond extending in a different direction. Additionally, bond lengths and angles, Van der Waals interactions, isoelectronic structures, and the like may vary among instances of the same chemical compound. Additionally, unless otherwise noted, the disclosed structures cover all stereoisomers, conformers, rotamers, isomers, and enantiomers of the represented compounds.

Numbered chemical structures are numbered using numbers, or numbers and letters.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s).

For purposes of this disclosure, and unless otherwise indicated, the term “substituted” refers to a hydrogen group has been replaced with a carbon atom, a heteroatom, or a heteroatom-containing group. For example, a “substituted hydrocarbyl” is a radical made of carbon and hydrogen where at least one hydrogen is replaced by a carbon atom, a heteroatom, or a heteroatom-containing group.

For purposes of this disclosure, and unless otherwise indicated, the term “carbon substituted” refers to a substituted species where a hydrogen group has been replaced with a carbon atom.

For purposes of this disclosure, and unless otherwise indicated, the term “heterosubstituted” refers to a substituted species where a hydrogen group has been replaced with a heteroatom or heteroatom-containing group.

For purposes of this disclosure, and unless otherwise indicated, formulation includes components of the formulation and/or reaction products thereof. Formulations can include blends.

For purposes of this disclosure, and unless otherwise indicated, the terms “hydrocarbyl radical,” “hydrocarbyl,” “hydrocarbyl group,” “alkyl radical,” and “alkyl” are used interchangeably throughout this document. Likewise, the terms “group,” “radical,” and “substituent” are also used interchangeably in this document. For purposes of this disclosure, “hydrocarbyl radical” refers to C₁-C₁₀₀ radicals, that may be linear, branched, or cyclic, and when cyclic, aromatic or non-aromatic. Examples of such radicals include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and their substituted analogues. Substituted hydrocarbyl radicals are radicals in which at least one hydrogen atom of the hydrocarbyl radical has been substituted with at least one halogen (such as Br, Cl, F or I) or at least one functional group such as C(O)R*, C(O)NR*₂, C(O)OR*, NR*₂, OR*, SeR*, TeR*, PR*₂, AsR*₂, SbR*₂, SR*, BR*₂, SiR*₃, GeR*₃, SnR*₃, and PbR*₃ (where R* is independently a hydrogen or hydrocarbyl radical, and two or more R* may join together to form a substituted or unsubstituted saturated, partially unsaturated or aromatic cyclic or polycyclic ring structure), or where at least one heteroatom has been inserted within a hydrocarbyl ring.

For purposes of this disclosure, and unless otherwise indicated, the term “alkenyl” refers to a straight-chain, branched-chain, or cyclic hydrocarbon radical having one or more double bonds. These alkenyl radicals may be optionally substituted. Examples of suitable alkenyl radicals include ethenyl, propenyl, allyl, 1,4-butadienyl cyclopropenyl, cyclobutenyl, cyclopentenyl, cyclohexenyl, cycloctenyl, including their substituted analogues.

For purposes of this disclosure, and unless otherwise indicated, the term “alkoxy” or “alkoxide” refers to an alkyl ether or aryl ether radical wherein the term alkyl is as defined above. Examples of suitable alkyl ether radicals include methoxy, ethoxy, n-propoxy, iso-propoxy, n-butoxy, iso-butoxy, sec-butoxy, tert-butoxy, and phenoxyl. For purposes of this disclosure, and unless otherwise indicated, “alkoxides” include those where the alkyl group is a C₁ to C₁₀₀ hydrocarbyl, such as a C₁ to C₃₀ hydrocarbyl, for example a C₁ to C₁₀ hydrocarbyl. The alkyl group may be straight chain, branched, or cyclic. The alkyl group may be saturated or unsaturated. In some embodiments, the alkyl group may include at least one aromatic group.

For purposes of this disclosure, and unless otherwise indicated, the term “aryl” (which is interchangeable with “aryl group” and “aryl radical”) includes a C₄ to C₆₀ aromatic ring, such as a C₄-C₂₀ aromatic ring, such as a six carbon aromatic ring, and the substituted variants thereof, including phenyl, 2-methyl-phenyl, xylyl, 4-bromo-xylyl. Likewise “heteroaryl” (which is interchangeable with “heteroaryl group” and “heteroaryl radical”) or refers to an aryl group where a ring carbon atom (or two or three ring carbon atoms) has been replaced with a heteroatom, preferably N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

For purposes of this disclosure, and unless otherwise indicated, a “ring structure” refers to atoms bonded together in one or more cyclic arrangements.

For purposes of this disclosure, and unless otherwise indicated, the term “ring atom” refers to an atom that is part of a cyclic ring structure. By this definition, a benzyl group has six ring atoms and tetrahydrofuran has 5 ring atoms.

For purposes of this disclosure, and unless otherwise indicated, a heterocyclic ring is a ring having a heteroatom in the ring structure as opposed to a heteroatom-substituted ring where a hydrogen on a ring atom is replaced with a heteroatom. For example, tetrahydrofuran is a heterocyclic ring and 4-N,N-dimethylamino-phenyl is a heteroatom-substituted ring.

Where isomers of a named alkyl, alkenyl, alkoxide, or aryl group exist (e.g., n-butyl, iso-butyl, iso-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

For any particular compound disclosed herein, any general or specific structure presented also encompasses all conformational isomers, regioisomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

### I. Resin Formulations

Resins (e.g., epoxy resins) are useful as well sealants for construction, remediation, and abandonment. Epoxy (resin introduced as a fluid and hardened in situ) is used as a specialty sealant in the upstream petroleum industry for repairing leaks originating in well barriers, i.e., to repair leaks in a cement sheath previously formed between sections of casing of different diameters, previously formed around the casing to seal between the casing and the earth of the drilled well bore, and previously formed at other locations of the well or casing. The leaks best suited to being repaired using epoxy resin, as opposed to using additional cement sealant, are usually small in cross-sectional area and difficult to access which makes the use of Portland cement, the traditional sealant for sealing well leaks, ineffective. Since epoxy resin is initially prepared in a fluid state by intermixing one or more resins and one or more hardener, with additives such as reaction accelerators and weighing agents, which mixture then reacts to harden and form a solid seal, it is ideally suited to be injected into small areas, such as pores or cracks in a previously formed Portland cement seal through which a leak is occurring, and allowed to set to form a seal to seal the cracks or pores in the previously placed seal material, and hence, the leak. Since epoxy in fluid form is cohesive in water or brine, an epoxy fluid formulated to be denser than well fluid can be introduced into a brine-filled casing or annulus well above a leak location in a well, below which a packer or other obstacle is set. The epoxy will fall to the bottom of the brine-filled space, where it will set and form a seal.

Volumetric penetration, i.e., the ability to enter into openings such as pores or cracks in a previously formed seal, or into a formation from which hydrocarbons have or may be produced, and the cohesion characteristics of epoxy resin when exposed to brine, make epoxy resin an ideal sealant for difficult well sealing applications in which remediation with Portland cement would require extensive well preparation (drilling, milling and cutting the casing, etc.) and large sealant volumes. Epoxy resin sealant can be locally mixed adjacent to the well location and placed therein using normal petroleum industry mixing and well introduction methods. Repairs of a failed or failing Portland cement well seal using an epoxy resin sealant usually requires significantly (as much as 10 times) less volume of sealant as compared to the sealant volume required when using additional Portland cement to repair a failed or failing Portland cement seal. This reduced volume of sealant is a consequence of epoxy resin's superior mechanical properties, its cohesiveness which inhibits contamination and intermixing therewith with other well fluids which degrades the resulting seal integrity, and its superior penetrating ability into small openings, as compared to Portland cement.

A resin having an improved bond strength to a pipe or annulus is described below. The resin formulations include a resin (e.g., an epoxy resin or furan resin), a surfactant, and one or more additives such as hardeners, reactive diluents, non-reactive diluents, silanes, weighting agents, solid particulate fillers, defoamers, solid particulates, bonding aids, reaction accelerators, antifoaming agents, and micronized rubber.

### Resins

Resins such as curable resins include epoxy resins and furan resins. Exemplary epoxy resins include one or more of the following: phenol-formaldehyde polymer glycidyl ether; 4,4′-isopropylidenediphenol-epichlorohydrin copolymer; bisphenol A-derived epoxy resins such as bisphenol-A diglycidyl ether epoxy resin; bisphenol F-derived epoxy resins such as bisphenol-F diglycidyl ether epoxy resin; novolac epoxy resins (e.g., epoxy phenol novolacs and epoxy cresol novolacs); aliphatic epoxy resin, such as monofunctional aliphatic epoxy resins (e.g., dodecanol glycidyl ether), difunctional aliphatic epoxy resins (e.g., butanediol diglycidyl ether), polypropylene glycol-based epoxy resins, or higher functionality aliphatic epoxy resins (e.g., trimethylolpropane triglycidyl ether); cycloaliphatic epoxy resin, such as those containing one or more cycloaliphatic rings in the molecule (e.g., 3,4-epoxycyclohexylmethyl-3,4-epoxycyclohexane carboxylate); and glycidylamine epoxy resins such as triglycidyl-p-aminophenol and N,N,N′,N′-tetraglycidyl-bis-(4-aminophenyl)-methane. The resin formulation may include formaldehyde, polymer with 1,3-dimethylbenzene.

Exemplary furan resins include furan-phenolic resins, furan-urea resins, and combinations thereof. Furan resins also include those made from furfural, furfural derivatives, and hydroxymethylfurfural derivatives such as furfuryl alcohol; furan; 2-methyl furan; tetrahydrofuran; furoic acids; furoates; difuranic coupled homologues; 2-furfurylamine; difurylic diamines; difuranic diisocyanates; 2-alkenylfurans; 2-furfurylidene methyl ketone and homologues; 2-furyloxirane and homologues; 2-vinyl furoate and homologues; 2-furfuyl acrylates and methacrylates; 2-furyl vinyl ketones; 2-furfuryl vinyl ethers; furanic isocyanates; 2,5-bis(hydroxymethyl)furan; 2,5-bis(formyl)furan; 2,5-furandicarboxylic acid, its chloride analogues and its ester analogues; 2,5-bis(aminomethyl)furan; furanic diisocyanates; 2,5-Bis(chloromethyl)furan; 2,5-hydroxymethylfuroic acid; 2-hydroxymethyl-5-furanacryl esters; and 2,5-furandiacrylic acid. Other exemplary furan resins can be found in U.S. Pat. No. 4,556,109, which is incorporated by reference herein in its entirety.

### Surfactants

It is contemplated that any surfactant can be used for the resin formulations. Surfactants contain a “head” X and a tail “Y”:

X-Y,

where X is a polar head group that is non-ionic, anionic, cationic, amphoteric, or zwitterionic; and Y is a chain of atoms, such as: a hydrocarbon chain, which can be branched, linear, and/or aromatic, substituted or unsubstituted; a fluorocarbon or a fluorocarbon-derived chain; a siloxane or a siloxane-derived chain; ethoxylated (polyethylene oxide-like) chains; and polypropylene oxide-like chains. Chains can be tailored to specific needs and requirements of, for example, hydrophobicity and hydrophilicity

Surfactants that can be employed in the resin formulations described herein include cationic surfactants, anionic surfactants, non-ionic surfactants, zwitterionic surfactants, biosurfactants, and combinations thereof. In the case of ionic surfactants, counterions include: monoatomic cations such as alkali metals, alkaline earth metals, and transition metals; monoatomic anions such as halides (Cl, Br, and I); polyatomic cations such as ammonium, pyridinium, and triethanolamine; and polyatomic anions such as sulfates, sulfonates, tosyls, trifluoromethesulfonates, phosphates, and phosphonates.

Exemplary cationic surfactants useful for the resin formulations include amines (primary, secondary, or tertiary) and quaternary amines such as the following compounds:

A quaternary amines represented by the formula (1):

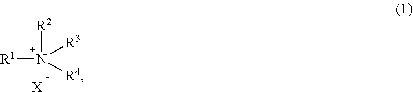

wherein:
each of R¹, R², R³ and R⁴ is independently a C₁-C₁₀₀ alkyl radical (such as a C₁-C₃₀ alkyl radical, for example a C₈-C₂₀ alkyl radical), a substituted C₁-C₁₀₀ alkyl radical (such as a substituted C₁-C₃₀ alkyl radical, for example a substituted C₈-C₂₀ alkyl radical), a C₁-C₁₀₀ alkenyl radical (such as a C₁-C₃₀ alkenyl radical, for example a C₈-C₂₀ alkenyl radical), a substituted C₁-C₁₀₀ alkenyl radical (such as a substituted C₁-C₃₀ alkenyl radical, for example a substituted C₈-C₂₀ alkenyl radical), an alkoxy radical (such as a C₁-C₂₀ alkoxy radical, such as an ethylene glycol and a polyethylene glycol), a substituted alkoxy radical (such as a C₁-C₂₀ substituted alkoxy radical, for example a C₁-C₈ substituted alkoxy radical), a C₄-C₆₀ aryl radical (such as a C₄-C₂₀ aryl radical, such as a C₆-C₁₄ aryl radical), a substituted C₄-C₆₀ aryl radical (such as a substituted C₄-C₂₀ aryl radical, such as a substituted C₆-C₁₄ aryl radical), a C₄-C₆₀ heteroaryl radical (such as a C₄-C₂₀ heteroaryl radical, such as a C₆-C₁₄ heteroaryl radical), or a substituted C₄-C₆₀ heteroaryl radical (such as a substituted C₄-C₂₀ heteroaryl radical, such as a substituted C₆-C₁₄ heteroaryl radical); wherein one or more R groups can be linear or branched; and
X is an anion, such as bromide and chloride.

Examples of quaternary amines of the formula (1) include cetyl trimethyl ammonium bromide, dodecyl trimethyl ammonium bromide, coconut alkyl trimethyl ammoniums; and stearyltrimethyl ammonium chloride.

An alkylaryl ammonium represented by the formula (2):

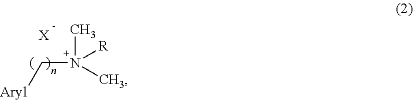

wherein:
Aryl is a C₄-C₆₀ aryl radical (such as a C₄-C₂₀ aryl radical, such as a C₆-C₁₄ aryl radical), a substituted C₄-C₆₀ aryl radical (such as a substituted C₄-C₂₀ aryl radical, such as a substituted C₆-C₁₄ aryl radical), a C₄-C₆₀ heteroaryl radical (such as a C₄-C₂₀ heteroaryl radical, such as a C₆-C₁₄ heteroaryl radical), or a substituted C₄-C₆₀ heteroaryl radical (such as a substituted C₄-C₂₀ heteroaryl radical, such as a substituted C₆-C₁₄ heteroaryl radical);
R is a C₁-C₁₀₀ alkyl radical (such as a C₁-C₃₀ alkyl radical, for example a C₈-C₂₀ alkyl radical), a substituted C₁-C₁₀₀ alkyl radical (such as a substituted C₁-C₃₀ alkyl radical, for example a substituted C₈-C₂₀ alkyl radical), a C₁-C₁₀₀ alkenyl radical (such as a C₁-C₃₀ alkenyl radical, for example a C₈-C₂₀ alkenyl radical), a substituted C₁-C₁₀₀ alkenyl radical (such as a substituted C₁-C₃₀ alkenyl radical, for example a substituted C₈-C₂₀ alkenyl radical), an alkoxy radical (such as a C₁-C₂₀ alkoxy radical, such as an ethylene glycol and a polyethylene glycol), a substituted alkoxy radical (such as a C₁-C₂₀ substituted alkoxy radical, for example a C₁ to C₈ substituted alkoxy radical) a C₄-C₆₀ aryl radical (such as a C₄-C₂₀ aryl radical, such as a C₆-C₁₄ aryl radical), a substituted C₄-C₆₀ aryl radical (such as a substituted C₄-C₂₀ aryl radical, such as a substituted C₆-C₁₄ aryl radical), a C₄-C₆₀ heteroaryl radical (such as a C₄-C₂₀ heteroaryl radical, such as a C₆-C₁₄ heteroaryl radical), or a substituted C₄-C₆₀ heteroaryl radical (such as a substituted C₄-C₂₀ heteroaryl radical, such as a substituted C₆-C₁₄ heteroaryl radical); wherein R can be linear or branched;
X is an anion, such as bromide and chloride; and
n is an integer from 1 to 50, such as from 8 to 18.

Examples of aryl and heteroaryl radicals of formula (2) include: phenyl, napthyl, anthracenyl, radicals pyridinyl radicals. Examples of alkylaryl ammoniums (2) include benzalkoniums, such as benzalkonium chlorides.

An ethoxylated alkyl amine represented by the formula (3):

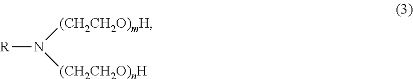

wherein:
R is a C₁-C₁₀₀ alkyl radical (such as a C₁-C₃₀ alkyl radical, for example a C₁ to C₁₈ alkyl radical), a substituted C₁-C₁₀₀ alkyl radical (such as a substituted C₁-C₃₀ alkyl radical, for example a substituted C₁ to C₁₈ alkyl radical), a C₁-C₁₀₀ alkenyl radical (such as a C₁-C₃₀ alkenyl radical, for example a C₁ to C₁₈ alkenyl radical), a substituted C₁-C₁₀₀ alkenyl radical (such as a substituted C₁-C₃₀ alkenyl radical, for example a substituted C₈-C₂₀ alkenyl radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched; and each of m and n is independently an integer of 1 or more, such as from 2 to 50, for example from 2 to 15.

Other examples of cationic surfactants include octenidine dihydrochloride, cetylpyridinium chloride, benzethonium chlorides, dimethyldioctadecylammonium chloride, dimethyldioctadecylammonium bromide, didecyldimethylammonium chloride, dioctadecyldimethylammonium bromide, and analogs thereof.

Exemplary anionic surfactants useful for the resin formulations include:

An alkyl aryl sulfonate represented by the formula (4a):

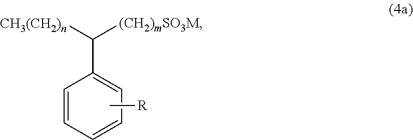

wherein:
R is a hydrogen, a C₁-C₁₀₀ alkyl radical (such as a C₁-C₃₀ alkyl radical, for example a C₈ to C₂₀ alkyl radical or a C₁ to C₁₀ alkyl radical), a substituted C₁-C₁₀₀ alkyl radical (such as a substituted C₁-C₃₀ alkyl radical, for example a substituted C₈ to C₂₀ alkyl radical or a substituted C₁ to C₁₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched;
each of m and n is independently an integer of 1 or more, such as from 1 to 100, such as from 9 to 30; and
M is a cation, such as a monovalent cation such as ammonium, sodium, lithium, or potassium.

An alkyl aryl sulfonate represented by the formula (4b):

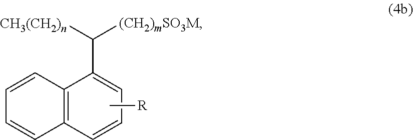

wherein:
R is a hydrogen, a C₁-C₁₀₀ alkyl radical (such as a C₁-C₃₀ alkyl radical, for example a C₈ to C₂₀ alkyl radical or a C₁ to C₁₀ alkyl radical), a substituted C₁-C₁₀₀ alkyl radical (such as a substituted C₁-C₃₀ alkyl radical, for example a substituted C₈ to C₂₀ alkyl radical or a substituted C₁ to C₁₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched;
each of m and n is independently an integer of 1 or more, such as from 1 to 100, such as from 9 to 30; and
M is a cation, such as a monovalent cation such as ammonium, sodium, lithium, or potassium.

In some examples of alkyl aryl sulfonate (4a, 4b), R is an alkyl sulfonate group. Examples of alkyl aryl sulfonates (4a, 4b) include alkylbenzene sulfonic acids and their salts, dialkylbenzene disulfonic acids and their salts, dialkylbenzene sulfonic acids and their salts, alkyltoluene/alkyl xylene sulfonic acids and their salts, alkylnaphthalene sulfonic acids/condensed alkyl naphthalene sulfonic acids and their salts, alkylphenol sulfonic acids/condensed alkylphenol sulfonic acids and their salts.

An alkyl benzene sulfonate represented by the formula (5):

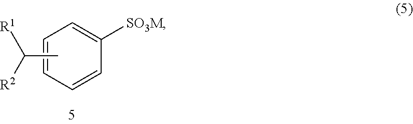

wherein:
each of R¹ and R² is independently a C₁-C₁₀₀ alkyl radical (such as a C₁-C₃₀ alkyl radical, for example a C₈ to C₂₀ alkyl radical), a substituted C₁-C₁₀₀ alkyl radical (such as a substituted C₁-C₃₀ alkyl radical, for example a substituted C₈ to C₂₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein one or more R groups can be linear or branched; and

When at least one of R¹ and R² of formula (5) is branched, the compounds are known as branched alkyl benzene sulfonates (BABS), such as C₁₅₋₁₈ BABS and C₁₆₋₁₈ BABS, which are also useful surfactants for the formulations described herein.

An alkyl sulfate represented by the formula (6):

R—O—SO₃M (6),

wherein:
R is a C₁-C₁₀₀ alkyl radical (such as a C₁-C₃₀ alkyl radical, for example a C₈ to C₂₀ alkyl radical), a substituted C₁-C₁₀₀ alkyl radical (such as a substituted C₁-C₃₀ alkyl radical, for example a substituted C₈ to C₂₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched; and
M is a cation, such as a monovalent cation such as ammonium, sodium, lithium, or potassium.

Examples of alkyl sulfates (6) include sodium lauryl sulfate, sodium dodecyl sulfate and sodium octyl sulfate.

An alcohol propoxy sulfate represented by the formula (7):

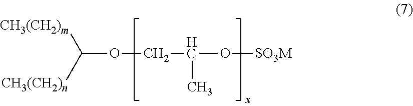

wherein:
each of m and n is independently an integer of 1 or more, such as from 1 to 100, such as from 9 to 30, such as 16 and 17;
x is an integer of 1 or more, such as from 1 to 100, such as from 1 to 30, such as 7; and
M is a cation, such as a monovalent cation such as ammonium, sodium, lithium, or potassium.

An alkyl (or alcohol) ethoxy sulfate represented by the formula (8):

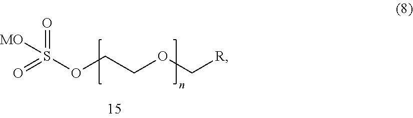

wherein R is a C₁-C₁₀₀ alkyl radical (such as a C₁-C₃₀ alkyl radical, for example a C₈ to C₂₀ alkyl radical), a substituted C₁-C₁₀₀ alkyl radical (such as a substituted C₁-C₃₀ alkyl radical, for example a substituted C₈ to C₂₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched; and
n is an integer of 1 or more, such as from 1 to 100, such as from 2 to 40; and
M is a cation, such as a monovalent cation, such as ammonium, sodium, lithium, and potassium.

A Guerbet alkoxy sulfate represented by the formula (9):

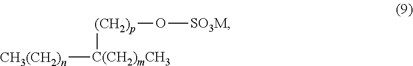

wherein:
each of n, m, and p is independently an integer of 1 or more, such as from 1 to 100, such as from 1 to 50, such as from 12 to 44; and
M is a cation, such as a monovalent cation such as ammonium, sodium, lithium, and potassium.

The alkyl chains of the Guerbet alkoxy sulfate (9) can be branched or linear, substituted or unsubstituted.

An n-ethoxy sulfonates represented by the formula (10):

H—(OCH₂CH₂)ₙ—O—SO₂—R (10),

wherein:
a C₁-C₁₀₀ alkyl radical (such as a C₁-C₃₀ alkyl radical, for example a C₈ to C₂₀ alkyl radical), a substituted C₁-C₁₀₀ alkyl radical (such as a substituted C₁-C₃₀ alkyl radical, for example a substituted C₈ to C₂₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched; and n is an integer of 1 or more, such as from 1 to 100, such as from 1 to 20.

Examples of n-ethoxy sulfonates (10) include 7-ethoxy sulfonate and 15-ethoxy sulfonate.

An alpha olefin sulfonate represented by the formula (11):

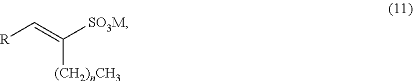

wherein:
R is a C₁-C₁₀₀ alkyl radical (such as a C₁-C₃₀ alkyl radical, for example a C₈ to C₂₀ alkyl radical), a substituted C₁-C₁₀₀ alkyl radical (such as a substituted C₁-C₃₀ alkyl radical, for example a substituted C₈ to C₂₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched;
n is an integer of 1 or more, such as from 1 to 100, such as from 1 to 20, such as from 10 to 20; and
M is a cation, such as a monovalent cation such as ammonium, sodium, lithium, and potassium.

Examples alpha-olefin sulfonates represented by the formula (11) include sodium C14-C16 olefin sulfonate and sodium alpha-olefin (C12) sulfonate.

An alpha olefin sulfate represented by the formula (12):

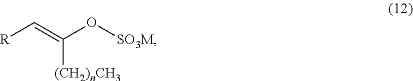

wherein:
R is a R is a C₁-C₁₀₀ alkyl radical (such as a C₁-C₃₀ alkyl radical, for example a C₈ to C₂₀ alkyl radical), a substituted C₁-C₁₀₀ alkyl radical (such as a substituted C₁-C₃₀ alkyl radical, for example a substituted C₈ to C₂₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched;
n is an integer of 1 or more, such as from 1 to 100, such as from 1 to 20, such as from 10 to 20; and
M is a cation, such as a monovalent cation such as ammonium, sodium, lithium, and potassium.

An alkyl polyalkoxy alkyl sulfonate and an alkylaryl polyalkoxy alkyl sulfonate represented by the formula (13):

RO(R′O)ₙR″SO₃M (13),

wherein:
R is a C₁-C₁₀₀ alkyl radical (such as a C₁-C₃₀ alkyl radical, for example a C₈ to C₂₄ alkyl radical), a substituted C₁-C₁₀₀ alkyl radical (such as a substituted C₁-C₃₀ alkyl radical, for example a substituted C₈ to C₂₄ alkyl radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched;

R′ is an alkyl radical (such as a C₁ to C₁₀ alkyl radical or substituted C₁ to C₁₀ alkyl radical), such as ethyl, propyl, or a mixture of ethyl and propyl;

R″ is a C₁ to C₁₀ alkyl (substituted or unsubstituted) or C₁ to C₁₀ alkoxy radical (substituted or unsubstituted) such as ethyl, propyl, butyl and hydroxypropyl;

n is an integer from 1 to 100, such as from 1 to 20, such as from 2 to 8; and

M is a cation, such as a monovalent cation, such as ammonium, sodium, lithium, or potassium.

When R is an alkyl radical, formula (13) is an alkyl polyalkoxy alkyl sulfonate, and When R is an alkylaryl radical, formula (13) is an alkylaryl polyalkoxy alkyl sulfonate.

A sulfonated, ethoxylated alcohol represented by the formula (14):

RO(CH₂)(CH₂)ₓCH₂CH₂SO₃M (14),

wherein:
R is a C₁-C₁₀₀ alkyl radical (such as a C₁-C₃₀ alkyl radical, for example a C₈ to C₂₄ alkyl radical), a substituted C₁-C₁₀₀ alkyl radical (such as a substituted C₁-C₃₀ alkyl radical, for example a substituted C₈ to C₂₄ alkyl radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein R can be linear or branched;
x is an integer of 1 or more, such as from 1 to 100, such as from 1 to 20; and
M is a cation, such as a monovalent cation such as ammonium, sodium, lithium, and potassium.

Other anionic surfactants include: tridecyl-9-propylene oxide-sulfate; ethoxy glycidyl sulfonates; and propoxy glycidyl sulfonates; esterquats; docusate sodium (C₂₀H₃₇NaO₇S); alkyl ether sulfates; gemini anionic surfactants; sulfonated, ethoxylated alkyl phenols; sodium petroleum sulfonates; alkyl alcohol propoxylated sulfates (such as propoxylated C₁₂ to C₂₀ alcohol sulfates); and internal olefin sulfonates.

Exemplary non-ionic surfactants useful for the resin formulations include:

An alkyl ethoxy carboxylated represented by the formula (15):

RO(CH₂CH₂O)ₓCH₂COOM (15),

wherein:
R is a C₁ to C₁₀₀ alkyl radical (such as a C₁-C₃₀ alkyl radical, such as a C₈ to C₁₈ alkyl radical), a substituted C₁ to C₁₀₀ alkyl radical (such as a substituted C₁-C₃₀ alkyl radical, such as a substituted C₈ to C₁₈ alkyl radical), an alkylaryl radical where the alkyl group of the alkylaryl radical is a substituted or unsubstituted C₁ to C₁₀₀ alkyl radical (such as a substituted or unsubstituted C₁ to C₂₀ alkyl radical, such as a substituted or unsubstituted C₈ to C₂₀ alkyl radical); and the R group can be linear or branched;
x is an integer of 1 or more, such as from 1 to 100, such as from 1 to 15; and
M is a cation, such as an alkali metal or an alkaline earth metal.

A nonylphenol-n-ethoxylates represented by the formula (16):

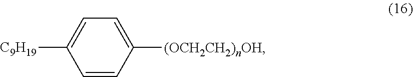

wherein:
n is an integer of 1 or more, such as from 1 to 100, such as from 1 to 15.

A secondary alcohol n-ethoxylate and/or n-propoxylate represented by the formula (17):

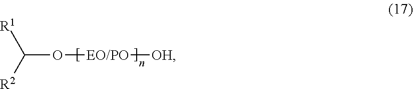

wherein:
each of R¹ and R² is independently a C₁-C₁₀₀ alkyl radical (such as a C₁-C₃₀ alkyl radical, for example a C₈ to C₂₀ alkyl radical), a substituted C₁-C₁₀₀ alkyl radical (such as a substituted C₁-C₃₀ alkyl radical, for example a substituted C₈ to C₂₀ alkyl radical), a C₁-C₁₀₀ alkenyl radical (such as a C₁-C₃₀ alkenyl radical, for example a C₈ to C₂₀ alkenyl radical), a substituted C₁-C₁₀₀ alkenyl radical (such as a substituted C₁-C₃₀ alkenyl radical, for example a substituted C₈ to C₂₀ alkenyl radical), an alkoxy radical (such as a C₁ to C₂₀ alkoxy radical, such as an ethylene glycol and a polyethylene glycol), a substituted alkoxy radical (such as a C₁ to C₂₀ substituted alkoxy radical, for example a C₁ to C₈ substituted alkoxy radical), a C₄ to C₆₀ aryl radical (such as a C₄ to C₂₀ aryl radical, such as a C₆ to C₁₄ aryl radical), a substituted C₄ to C₆₀ aryl radical (such as a substituted C₄ to C₂₀ aryl radical, such as a substituted C₆ to C₁₄ aryl radical), a C₄ to C₆₀ heteroaryl radical (such as a C₄ to C₂₀ heteroaryl radical, such as a C₆ to C₁₄ heteroaryl radical), or a substituted C₄ to C₆₀ heteroaryl radical (such as a substituted C₄ to C₂₀ heteroaryl radical, such as a substituted C₆ to C₁₄ heteroaryl radical); wherein one or more R groups can be linear or branched; and
EO is ethylene oxide;
PO is propylene oxide; and
n is an integer of 1 or more, such as from 1 to 100, such as from 1 to 20.

In formula (17), ethylene oxide and propylene oxide can exist in one compound or in separate compounds.

Alcohols and alcohol ethoxylates, such as C₁ to C₁₀₀ alcohols (such as C₁ to C₃₀ alcohols, such as C₁₀ to C₂₀ alcohols), and C₁ to C₁₀₀ alcohols (such as C₁ to C₃₀ alcohols, such as C₁₀ to C₂₀ alcohols) that are reacted with ethylene oxide to produce the alcohol ethoxylates. Such alcohols and alcohol ethoxylates include hydrocarbyl, aryl, and heteroaryl, and may be substituted or unsubstituted, and can be linear or branched. Sulfated analogs of alcohols and alcohol ethoxylates may also be used. Blends of different alcohols, blends of different ethoxylates, blends of ethoxysulfates, and combinations thereof may also be used.

Alcohol propoxylates and alcohol propoxylate sulfates, such as C₁ to C₁₀₀ alcohols (such as C₁ to C₃₀ alcohols, such as C₁₀ to C₂₀ alcohols) that are reacted with propylene oxide to produce the alcohol propoxylates. Sulfated analogs of alcohol propoxylates may also be used. Blends of different alcohols, blends of different ethoxylates, and blends of alcohols and ethoxylates may also be use.

Alkyl phenoxypolyethoxylethanol, such as octyl phenoxypolyethoxylethanol and nonyl phenoxypolyethoxylethanol.

Additionally, non-ionic surfactants include fatty alcohol ethoxylates (such as octaethylene glycol monododecyl ether and pentaethylene glycol monododecyl ether); fatty acid ethoxylates; tridecyl alcohol 30 ethoxylate (C₁₃H₂₇(OCH₂CH₂)₃₀OH); ethoxylated fatty esters and oils; ethoxylated amines and/or fatty acid amides (such as polyethoxylated tallow amine, cocamide monoethanolamine, and cocamide diethanolamine); Poloxamers; fatty acid esters of polyhydroxy compounds; fatty acid esters of glycerol (such as glycerol monostearate and glycerol monolaurate); fatty acid esters of sorbitol (such as sorbitan monolaurate, sorbitan monostearate, sorbitan oleate, sorbitan trioleate, and sorbitan tristearate), and the Tweens (such as polyoxyethylene (20) sorbitan monolaurate, polyoxyethylene (20) sorbitan monopalmitate, polyoxyethylene (20) sorbitan monostearate, and polyoxyethylene (20) sorbitan monooleate, where 20 refers to the number of oxyethylene groups); fatty acid esters of sucrose; amine oxides such as lauryldimethylamine oxide; polyethoxylated alkylphenols (such as nonoxynols and 4-Octylphenol polyethoxylate); poly (ethylene/propylene) glycol ethers; alkyl polyglycosides (such as decyl glucoside, lauryl glucoside, and octyl glucoside); poloxamers (such as triblock copolymers comprising a polyoxypropylene flanked by polyoxyethylene); modified triphenylmethanes; and organic acids.

Exemplary zwitterionic surfactants useful for the resin formulations include sultaines, such as 3-[(3-Cholamidopropyl)dimethylammonio]-1-propanesulfonate) and cocamidopropyl hydroxysultaine; betaines such as cocamidopropyl betaine; and phospholipids such as phosphatidylserine, phosphatidylethanolamine, phosphatidylcholine, and sphingomyelins.

Exemplary biosurfactants useful for the resin formulations include lipopeptides, lipoproteins, rhamnolipids, polyol lipids, trehalolipids, ornithine lipids, sophorose lipids, sophorolipids, surfactin, lichenysin, fatty acids, phospholipids, neutral lipids, polymeric biosurfactants (e.g., emulsan, liposan, alasan, lipomanan, and other polysaccharide-protein complexes), viscosin, diglycosyl diglycerides, and glycolipids.

One or more different surfactants may be used for the resin formulations.

Chemical descriptions and physical properties of example surfactants that can be used in the resin formulations are provided in Table 1.

TABLE 1
Example Surfactants - Chemical and Physical Properties

| | Surfactant 1 | Surfactant 2 | Surfactant 3 | Surfactant 4 | Surfactant 5 |
|---|---|---|---|---|---|
| Description | Tall oil fatty | Polyamide and | Sorbitan | Ethoxylated | Sorbitan |
| | acid and | paraffinic | sesquioleate | sorbitan | trioleate |
| | diesel fuel | solvent | | monooleate | |
| | | (predominantly | | | |
| | | C₁₀ through C₁₅) | | | |
| Appearance | Dark, amber | Dark, amber | Clear, | Viscous, | Viscous, |
| | liquid | liquid | amber liquid | yellowish liquid | amber liquid |
| pH | 10 to 12.5 | 3.23 (5% in 1:1 | NA | 6 to 7 (sol 5%, | NA |
| | | IPA:Water) | | 25° C.) | |
| Flash Point | 88° C. | >85° C. | >100° C. | >150° C. | 148.9° C. |
| Pour Point | NA | NA | NA | >20° C. | −26° C. |
| S.G. | 0.886 @ 20° C. | 0.92 @ 25° C. | 1.0 @ 25° C. | 1.08 @ 25° C. | 0.95 @ 25° C. |
| Water | Insoluble | NA | Insoluble | Soluble | NA |
| Solubility | | | | | |

| | Surfactant 6 | Surfactant 7 | Surfactant 8 | Surfactant 9 | Surfactant 10 |
|---|---|---|---|---|---|
| Description | Fatty acids, | Octylphenol | Ethoxylated | Sodium | Ethoxylated |
| | tail-oil, | ethoxylate | fatty alcohol | alkylnaphthalene- | nonylphenol |
| | ethoxylated | | | sulfonate | |
| Appearance | Clear to | Clear, pale | White solid | Tan Powder | Clear liquid |
| | slightly hazy, | yellow | | | |
| | yellow to | liquid | | | |
| | amber liquid | | | | |
| pH | 6.5 (5%) | 5 to 8 (5% | NA | 7.5 to 10 (5% | 6 |
| | | DI water) | | solution) | |
| Flash Point | >150° C. | >100° C. | >149° C. | >94° C. | 93° C. |
| Pour Point | <20° C. | <7.2° C. | 33° C. | NA | NA |
| S.G. | 1.04 | NA | 1.05 | NA | 1.06 @ 20° C. |
| Water | Dispersible | Dispersable | NA | Soluble | NA |
| Solubility | | | | | |

| | Surfactant 11 | Surfactant 12 | Surfactant 13 | Surfactant 14 |
|---|---|---|---|---|
| Description | Mixture of | Mixture of | Mixture of | Mixture of |
| | alcohols with | alcohols with | alcohols with | cocamide and |
| | ethanolamine, | sulfuric acid and | ethylene glycol | ethoxylated |
| | sulfuric acid, and | N-dodecylbenzene | and glycerol | alcohols |
| | methylbutyl | sulfonic acid, | | |
| | ketone | linear | | |
| Appearance | clear, light yellow | clear | Clear, colorless to | Pale |
| | to amber liquid | yellow liquid | light yellow liquid | yellow liquid |
| pH | 7 to 9 | 1 | 7 to 8 | 7 to 8 |
| Flash Point | 20° C. | 22.8° C. | 70° C. | 22° C. |
| Pour Point | NA | NA | NA | NA |
| S.G. | 0.887 to 0.962 | 0.937 | 1.019 | 1.01 |
| Water | Completely | Completely | Completely | Partially |
| Solubility | soluble | soluble | soluble | soluble |

Surfactant 1 is a mixture of materials that includes organic acid (such as a tall oil fatty acid) and diesel fuel

Surfactant 2 is a mixture of materials that includes polyamide and paraffinic solvent.

Surfactant 3 is a mixture of materials that includes sorbitan sesquioleate (about 100 wt %).

Surfactant 4 is a mixture of materials that includes ethoxylated sorbitan monooleate.

Surfactant 5 is a mixture of materials that includes sorbitan trioleate (about 100 wt %).

Surfactant 6 is a mixture of materials that includes fatty acids, tall-oil, ethoxylated (about 100 wt %).

Surfactant 7 is a mixture of materials that includes ethoxylated octylphenol (about 100 wt %) and a mixture of glycol ethers.

Surfactant 8 is a mixture of materials that includes ethoxylated fatty alcohol (about 100 wt %).

Surfactant 9 is a mixture of materials that includes sodium alkylnaphthalene-sulfonate (about 70 wt % to about 90 wt %).

Surfactant 10 is a mixture of materials that includes ethoxylated nonylphenol (about 60 wt % to about 100 wt %).

Surfactant 11 is a mixture of materials that includes isopropyl alcohol (about 30 wt % to about 60%), denatured ethyl alcohol (about 30 wt % to about 60%), methyl alcohol (about 0 wt % to about 10 wt %), ethanolamine (about 3 wt % to about 7 wt %), sulfuric acid (about 0 wt % to about 1.9 wt %), and methylisobutyl ketone (about 0 wt % to about 0.5 wt %).

Surfactant 12 is a mixture of materials that includes isopropyl alcohol (about 20 wt % to about 40%), denatured ethyl alcohol (about 20 wt % to about 40%), methyl alcohol (about 1 wt % to about 10 wt %), sulfuric acid (about 0 wt % to about 0.5 wt %), and N-dodecylbenzene sulfonic acid, linear.

Surfactant 13 is a mixture of materials that includes methyl alcohol (about 3 wt % to about 10 wt %), ethylene glycol (less than about 5 wt %), 2-butoxyethanol (about 3 wt % to about 10 wt %), and glycerol (about 0 wt % to about 1 wt %).

Surfactant 14 is a mixture of materials that includes poly(oxy-1,2-ethanediyl), alpha-sulfo-omega-hydroxy-, C6-12-alkyl ethers, ammonium salts (about 10 wt % to about 20 wt %), isopropyl alcohol (about 20 wt % to about 30 wt %), cocoamidopropyl betaine (about 20 wt % to about 30 wt %), glycerine (about 1 wt % to about 5 wt %), alcohols, C₈-C₁₀, ethoxylated (about 1 wt % to about 5 wt %), and cocamidopropyl dimethylamine (about 0.1 wt % to about 1 wt %).

### Optional Additives for the Resin Formulation

Besides the resin and the surfactant, the resin formulation further contains a hardener, and, optionally, one or more of reactive diluents, non-reactive diluents, silanes, weighting agents, solid particulate fillers, defoamers, solid particulates, bonding aids, reaction accelerators, antifoaming agents, and micronized rubber.

Diluents include reactive and nonreactive diluents such as alcohols, ethers, and glycidyl ethers. For example, cycloaliphatic difunctional epoxy reactive diluents (e.g., cyclohexanedimethanol diglycidyl ethers), monofunctional epoxy reactive diluents from cashew nut shell, aliphatic difunctional epoxy reactive diluents (e.g., 1,4-butanediol diglycidyl ethers and neopentyl glycol diglycidyl ethers), aliphatic monofunctional epoxy reactive diluents (e.g., C₁₂-C₁₄ diglycidyl ethers and C₈-C₁₀ diglycidyl ethers), aromatic monofunctional epoxy reactive diluents (e.g., cresyl glycidyl ethers and p-tertiarybutylphenol glycidyl ethers), aliphatic trifunctional epoxy reactive diluents (e.g., trimethylolpropane triglycidyl ethers).

Hardener/curing agents include amidoamine curing agents (such as formulations including methyleneoxide, polymer with benzene hydrogenated, benzyl alcohol, tetraethylenepentamine, Tofa, reaction products with TEPA) Mannich base curing agents (Tris-2,4,6-(dimethylaminomethyl)phenol, Bis(dimethylaminomethyl)phenol), polyoxypropylene diamine, trimethylolpropane poly(oxypropylene)triamine, triethylene tetramine, diethylene triamine, tetraethylenepentamine, diethyltoluenediamine, and mixtures thereof

Weighting agents include compositions comprising one or more of manganese tetraoxide (Mn₃O₄), iron oxide (Fe₂O₃), crystalline silica, silica, quartz, aluminum oxide, barite (BaSO₄), and silicon carbide.

Silanes include one or more of [3-(2,3-epoxypropoxy)propyl]trimethoxysilane, octyltriethoxysilane, methyltriethoxysilane, methyltrimethoxysilane, tris-[3-(trimethoxysilyl)propyl] isocyanurate, hexadecyltrimethoxysilane, vinyl silanes (e.g., Vinyltriethoxysilane, Vinyltrimethoxysilane, vinyl-tris-(2-methoxyethoxy) silane, oligomeric vinyl silane), methacryloxy silanes (e.g., gamma-methacryloxypropyltrimethoxysilane, methacrylamido-silane, gamma-methacryloxypropyltriethoxysilane, gamma-methacryloxypropyl-tris-(2-propoxy)silane), epoxy silanes (e.g., beta-(3,4-Epoxycyclohexyl)ethyltrimethoxysilane, beta-(3,4-epoxycyclohexyl)ethyltriethoxysilane, gamma-glycidoxypropyltrimethoxysilane, gamma-glycidoxypropyltriethoxysilane, 3-glycidoxypropylmethyldiethoxysilane, epoxysilane oligomer), sulfur silanes (e.g., gamma-mercaptopropyltrimethoxysilane, gamma-mercaptopropyltriethoxysilane, 3-octanoylthio-1-propyltriethoxysilane, oligomer mercaptosilane, 3-octanoylthio-1-propyltriethoxysilane, 3-octanoylthio-1-propylalkoxysilane), amino silanes (e.g., gamma-aminopropyltriethoxysilane, gamma-aminopropylsilsesquioxane, gamma-aminopropyltrimethoxysilane, N-beta-(aminoethyl)-gamma-aminopropyltrimethoxysilane, benzylamino-silane, triaminofunctional silane, bis-(gamma-triethoxysilylpropyl)amine, bis-(gamma-trimethoxysilylpropyl)amine, polyazamide, ethoxy based polyazamide, N-beta-(aminoethyl)-gamma-aminopropylmethyldimethoxysilane, N-ethyl-3-trimethoxysilyl-methylpropamine, Amino-functional oligosiloxane, Amino-functional oligosiloxane) ureido silanes (e.g., gamma-ureidopropyltrialkoxysilane and gamma-ureidopropyltrimethoxysilane), and isocyanate silanes (e.g., gamma-Isocyanatopropyltriethoxysilane and gamma-isocyanatopropyltrimethoxysilane). Solutions of the aforementioned silanes such as methanol solutions, ethanol solutions, and aqueous solutions may be used.

Exemplary antifoaming agents include polyglycol ethers and silicone.

The formulations can be mixed by techniques known in the art such as by batch mixing and on the fly.

### Formulation

The formulations include a resin, a surfactant, a hardener, and optionally, one or more additives. Exemplary formulations include one or more of the following characteristics:

1) Resin(s) (or curable resin(s)).

2) A concentration of surfactant(s) in the formulation at a weight percent of greater than about 0.01 wt %, such as from about 0.1 wt % to about 5 wt %, such as from about 0.25 wt % to about 3 wt %, such as about 0.5 wt %, about 1.0 wt %, about 1.5 wt %, about 2.0 wt %, or about 2.5 wt %, based on the total weight of the resin(s) (or curable resin(s)).

3) A concentration of diluent(s) in the formulation at a weight percent of from about 1 wt % to about 99 wt %, such as from about 5 wt % to about 90 wt %, such as from about 10 wt % to about 90 wt %, such as from about 20 wt % to about 75 wt %, such as from about 20 wt % to about 60 wt %, such as from about 20 wt % to about 50 wt %, such as from about 20 wt % to about 40 wt %, based on the total weight of the resin(s) (or curable resin(s)).

4) A concentration of hardener(s) in the formulation at a weight percent of from about 1 wt % to about 99 wt %, such as from about 10 wt % to about 90 wt %, such as from about 15 wt % to about 80 wt %, such as from about 15 wt % to about 60 wt %, such as from about 15 wt % to about 55 wt %, such as from about 15 wt % to about 50 wt %, such as from about 15 wt % to about 40 wt %, such as about 25 wt % or about 35 wt %, based on the total weight of the resin(s) (or curable resin(s)).

5) A concentration of silane(s) in the formulation at a weight percent of from about 0.1 wt % to about 99 wt %, such as from about 0.5 wt % to about 90 wt %, such as from about 0.5 wt % to about 80 wt %, such as from about 0.5 wt % to about 20 wt %, such as from about 0.5 wt % to about 10 wt %, such as about less than 5 wt %, such as about 2 wt %, such as about 1 wt %, such as about 0.5 wt %, such as about 0.1 wt %, based on the total weight of the resin(s) (or curable resin(s)).

6) A weighting agent(s) added to the formulation to reach a density of from about 10.0 lb/gal to about 20.0 lb/gal, such as from about 11.5 lb/gal to about 16.0 lb/gal, such as about 12.0 lb/gal to about 13.5 lb/gal, based on the total weight of the resin(s). The density is calculated by using the specific gravity of each of the materials to add up the weight and volume of the composite. The density can be measured by a pycnometer.

7) Micronized rubber(s) in the formulation, such as from about 5 wt % to about 30 wt %, such as from about 5 wt % to about 20 wt %, such as about 10 wt % or about 15 wt %, based on the total weight of the resin(s). Exemplary micronized rubber includes reprocessed ground rubber, such as reprocessed ground rubber with particle size less than 20 mesh.

8) A concentration of antifoaming agent(s) in the formulation, such as from about 1 wt % to about 99 wt %, such as from about 0.01 wt % to about 5.0 wt %, such as from about 0.1 wt % to about 2.5 wt %, such as from about 0.25 wt % to about 1.0 wt %, based on the total weight of the resin(s) (or curable resin(s)).

### Results

The flow resistance or seal durability is measured by hydraulic bond and shear bond. Hydraulic bond testing entails applying incrementally-increasing hydraulic or pneumatic pressure to a pipe or annulus containing a hardened resin barrier. The hydraulic bond of the resin is reported as the highest applied pressure at which the barrier prevented flow. Shear bond measurement entails mechanically loading the barrier until it physically moves and de-bonds from the pipe. Shear bond is reported as stress required to de-bond the sealant divided by contact area of resin to the pipe.

Results of hydraulic bond performance testing of the resin formulations (Examples 1 and 2) and a comparative (Comparative 1) in a U-tube are presented in Table 2.

Base Composition A is a formulation including epoxy resin (the resin comprising phenol-formaldehyde polymer glycidyl ether and 4,4′-isopropylidenediphenol-epichlorohydrin copolymer); 20 wt % diluent comprising alkyl C₁₂-C₁₄ glycidyl ether; a total of 40 wt % low temperature amidoamine hardener formulations (wherein the hardener formulations comprise the following: methyleneoxide, polymer with benzamine hydrogenated; benzyl alcohol; tetraethylenepentamine; and tall oil fatty acids (Tofa), reaction products with TEPA); 2 wt % silane (comprising [3-(2,3-epoxypropoxy)propyl]trimethoxysilane); 1 wt % antifoaming agent comprising silicone; and a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Three resin formulations were tested in a U-tube Test: Base Composition A (Comparative 1), Base Composition A+1 wt % sorbitan trioleate (Example 1), and Base Composition A+1 wt % ethoxylated nonylphenol (Example 2).

TABLE 2
U-Tube Hydraulic Bond Test Results

| Sample | Hydraulic Bond (psi) | |
|---|---|---|
| Comparative 1 | <50 | psi |
| Example 1 | 100 | psi |
| Example 2 | 50 | psi |

Liquid displaced for this test was water.

A hydraulic bond of <50 psi refers to failure of the hydraulic bond as evidenced by flow of fluid past the epoxy seal before hydraulic pressure applied to the seal reached 50 psi. Hydraulic bond values refer to the highest hydraulic pressure at which the epoxy seal held pressure without flow.

The hydraulic bond strength increased by at least 25% when a surfactant is added, with the sorbitan trioleate as the surfactant (Example 1) having the highest hydraulic bond strength. This means that the addition of the surfactant to the resin formulation creates a more durable seal.

Results of hydraulic bond performance testing (3 tests) of the resin formulations (Examples 3, 4, 5, and 6) in a 6-inch length pipe are presented in Table 3.

Base Composition B is a formulation including epoxy resin (the resin comprising phenol-formaldehyde polymer glycidyl ether and 4,4′-isopropylidenediphenol-epichlorohydrin copolymer); 20 wt % diluent comprising alkyl C₁₂-C₁₄ glycidyl ether; a total of 40 wt % low temperature amidoamine hardener formulations (wherein the hardener formulations comprise the following: methyleneoxide, polymer with benzamine hydrogenated; benzyl alcohol; tetraethylenepentamine; and Tofa, reaction products with TEPA); 1 wt % of a mannich base hardener formulation (comprising tris-2,4,6-(dimethylaminomethyl)phenol and bis(dimethylaminomethyl)phenol); 2 wt % silane (comprising [3-(2,3-epoxypropoxy)propyl]trimethoxysilane); 1 wt % antifoaming agent comprising silicone; and a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Comparative 2 is Base Composition B, and Example 3 is Base Composition B+1 wt % sorbitan trioleate.

Base Composition C is a formulation including epoxy resin (the resin comprising phenol-formaldehyde polymer glycidyl ether and 4,4′-isopropylidenediphenol-epichlorohydrin copolymer); 20 wt % diluent comprising alkyl C₁₂-C₁₄ glycidyl ether; a total of 40 wt % low temperature amidoamine hardener formulations (wherein the hardener formulations comprise the following: methyleneoxide, polymer with benzamine hydrogenated; benzyl alcohol; tetraethylenepentamine; and Tofa, reaction products with TEPA); 2 wt % silane (comprising [3-(2,3-epoxypropoxy)propyl]trimethoxysilane); 1 wt % antifoaming agent comprising silicone; and a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Comparative 3 is Base Composition C, Example 4 is Base Composition C+1 wt % sorbitan trioleate, and Example 5 is Base Composition C+1 wt % ethoxylated nonylphenol.

Base Composition D is a formulation including epoxy resin (the resin comprising phenol-formaldehyde polymer glycidyl ether and 4,4′-isopropylidenediphenol-epichlorohydrin copolymer); 55 wt % diluent comprising alkyl C₁₂-C₁₄ glycidyl ether; 16 wt % hardener comprising diethyltoluenediamine; 2 wt % silane (comprising [3-(2,3-epoxypropoxy)propyl]trimethoxysilane); 0.5 wt % of a mannich base hardener formulation (comprising tris-2,4,6-(dimethylaminomethyl)phenol and bis(dimethylaminomethyl)phenol); 21.4% Silicon Carbide; 1 wt % antifoaming agent comprising silicone; and 11.5 wt % of a finely ground rubber with a particle size less than 20 mesh. Silicon carbide was added to reach a density of 12.5 lb/gal. Weight percent is based on the total amount of epoxy resin used for the formulation. Density is measured as previously described.

Comparative 4 is Base Composition D, and Example 6 is Base Composition D+1 wt % sorbitan trioleate.

TABLE 3
6-inch Pipe (Tube) Hydraulic Bond Test Results

| | Sample | Hydraulic Bond (psi) | |
|---|---|---|---|
| Test 1 | Comparative 2 | 600 | psi |
| | Example 3 | 900 | psi |
| Test 2 | Comparative 3 | <50 | psi |
| | Example 4 | 300 | psi |
| | Example 5 | 100 | psi |
| Test 3 | Comparative 4 | <100 | psi |
| | Example 6 | 200 | psi |

Liquid displaced for this test was 3% NaCl (aqueous solution).

A hydraulic bond of <100 psi refers to failure of the hydraulic bond as evidenced by flow of fluid past the epoxy seal before hydraulic pressure applied to the seal reached 100 psi. Hydraulic bond values refer to the highest hydraulic pressure at which the epoxy seal held pressure without flow.

Table 3 shows the hydraulic bond test results performed in a 6-inch pipe. The results in Test 1 showed that the addition of the surfactant to Base Composition B greatly enhanced the hydraulic bond strength by about 50% relative to the formulation without surfactant (see Comparative 2 and Example 3). The results in Test 2 showed that the addition of the surfactant to Base Composition C increased the hydraulic bond strength by at least 100%, and increased by more than 5× for sorbitan trioleate relative to the formulation without surfactant (see Comparative 3, Example 4, and Example 5). The results in Test 3 showed that the addition of the surfactant to Base Composition D increased the hydraulic bond strength by more than 100% for sorbitan trioleate (see Comparative 5 and Example 6) relative to the formulation without the surfactant (see Comparative 5 and Example 6).

Results of a shear bond performance testing of the resin formulation (Example 7) in a 6-inch length pipe are presented in Table 4.

Base Composition E is a formulation including an epoxy resin (the resin comprising phenol-formaldehyde polymer glycidyl ether and 4,4′-isopropylidenediphenol-epichlorohydrin copolymer); 55 wt % diluent comprising alkyl C₁₂-C₁₄ glycidyl ether; a total of 30.5 wt % low temperature hardener formulations (the hardener formulations comprising polyoxypropylene diamine and tetraethylenepentamine); 2 wt % silane (comprising [3-(2,3-epoxypropoxy)propyl]trimethoxysilane); 1 wt % antifoaming agent comprising silicone; and an amount of a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Comparative 5 is Base Composition E, and Example 7 is Base Composition E+1 wt % sorbitan trioleate.

TABLE 4
6-inch Pipe (Tube) Shear Bond Test Results

| Sample | Shear Bond (psi) |
|---|---|
| Comparative 5 | 190 psi |
| Example 7 | 335 psi |

Table 4 shows the shear bond test results performed in a 6-inch length of 2-inch diameter pipe. The addition of the sorbitan trioleate (Example 7) greatly enhances the shear bond strength of the formulation, having an increase of more than 75%. Shear bond is a measure of mechanical resistance of the resin sealant plug to movement. The shear bond breaks when the plug moves as a whole.

Results of hydraulic bond performance testing of the resin formulations (Examples 8-26) in a 6-inch length pipe (tube) are presented in Table 5.

Base Composition F is a formulation including epoxy resin (the resin comprising phenol-formaldehyde polymer glycidyl ether and 4,4′-isopropylidenediphenol-epichlorohydrin copolymer); 20 wt % diluent comprising alkyl C₁₂-C₁₄ glycidyl ether; 1 wt % of a mannich base hardener formulation (comprising tris-2,4,6-(dimethylaminomethyl)phenol and bis(dimethylaminomethyl)phenol); a total of 40 wt % low temperature amidoamine hardener formulations (wherein the hardener formulations comprise the following: methyleneoxide, polymer with benzamine hydrogenated; benzyl alcohol; tetraethylenepentamine; and tall oil fatty acids (Tofa), reaction products with TEPA); 2 wt % silane (comprising [3-(2,3-epoxypropoxy)propyl]trimethoxysilane); 1 wt % antifoaming agent comprising silicone; and a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Base Composition G is a formulation including epoxy resin (the resin comprising phenol-formaldehyde polymer glycidyl ether and 4,4′-isopropylidenediphenol-epichlorohydrin copolymer); 20 wt % diluent comprising alkyl C₁₂-C₁₄ glycidyl ether; 1 wt % of a mannich base hardener formulation (comprising tris-2,4,6-(dimethylaminomethyl)phenol and bis(dimethylaminomethyl)phenol); a total of 25.4 wt % low temperature hardener formulations (the hardener formulations comprising polyoxypropylene diamine and tetraethylenepentamine); 2 wt % silane (comprising [3-(2,3-epoxypropoxy)propyl]trimethoxysilane); 1 wt % antifoaming agent comprising silicone; and a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Base Composition H is a formulation including epoxy resin (the resin comprising phenol-formaldehyde polymer glycidyl ether and 4,4′-isopropylidenediphenol-epichlorohydrin copolymer); 20 wt % diluent comprising alkyl C₁₂-C₁₄ glycidyl ether; 3 wt % of a mannich base hardener formulation (comprising tris-2,4,6-(dimethylaminomethyl)phenol and bis(dimethylaminomethyl)phenol); 30 wt % hardener comprising diethyltoluenediamine; 2 wt % silane (comprising [3-(2,3-epoxypropoxy)propyl]trimethoxysilane); 1 wt % antifoaming agent comprising silicone; and a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Base Composition I is a formulation including epoxy resin (the resin comprising phenol-formaldehyde polymer glycidyl ether and 4,4′-isopropylidenediphenol-epichlorohydrin copolymer); 20 wt % diluent comprising alkyl C₁₂-C₁₄ glycidyl ether; a total of 42.6 wt % low temperature hardener formulations (the hardener formulations comprising polyoxypropylene diamine and tetraethylenepentamine); 2 wt % silane (comprising [3-(2,3-epoxypropoxy)propyl]trimethoxysilane); 1 wt % antifoaming agent comprising silicone; and a weighting agent (comprising Mn₃O₄ and Fe₂O₃) added to the formulation for the formulation to reach a density of 13.5 lb/gal. Weight percent is based on the total amount of epoxy resin used for the formulation. Density is measured as previously described.

Comparative 6 is Base Composition F, Example 8 is Base Composition F+1 wt % sorbitan trioleate, and Example 9 is Base Composition F+1 wt % ethoxylated nonylphenol.

Comparative 7 is Base Composition G, Example 10 is Base Composition G+1 wt % sorbitan trioleate, and Example 11 is Base Composition G+1 wt % ethoxylated nonylphenol.

Comparative 8 is Base Composition H.

Example 12 is Base Composition H+1 wt % sorbitan trioleate.

Example 13 is Base Composition H+1 wt % ethoxylated nonylphenol.

Example 14 is Base Composition H+1 wt % Surfactant 11.

Example 15 is Base Composition H+1 wt % Surfactant 12.

Example 16 is Base Composition H+0.5 wt % Surfactant 1 (organic acid and diesel fuel)+0.5 wt % Surfactant 2 (polyamide and paraffinic solvent (predominantly C₁₀ through C₁₅)).

Example 17 is Base Composition H+0.7 wt % Surfactant 2 (polyamide and paraffinic solvent (predominantly C₁₀ through C₁₅)).

Example 18 is Base Composition H+0.7 wt % Surfactant 1 (organic acid and diesel fuel).

Example 19 is Base Composition H+1 wt % Surfactant 14.

Example 20 is Base Composition H+1 wt % Surfactant 13.

Example 21 is Base Composition H+0.5 wt % Surfactant 1 (organic acid and diesel fuel)+0.5 wt % Surfactant 2 (polyamide and paraffinic solvent (predominantly C₁₀ through C₁₅))+an additional 1.0 wt % of a mannich base hardener formulation (comprising tris-2,4,6-(dimethylaminomethyl)phenol and bis(dimethylaminomethyl)phenol).

Example 22 is Base Composition H+0.1 wt % Surfactant 1 (organic acid and diesel fuel)+0.1 wt % Surfactant 2 (polyamide and paraffinic solvent (predominantly C₁₀ through C₁₅)).

Comparative 9 is Base Composition I.

Example 23 is Base Composition I+0.25 wt % Surfactant 1 (organic acid and diesel fuel)+0.25 wt % Surfactant 2 (polyamide and paraffinic solvent (predominantly C₁₀ through C₁₅)).

Example 24 is Base Composition I+0.25 wt % Surfactant 13.

TABLE 5
6-inch Pipe (Tube) Test Hydraulic Bond Test Results

| | Maximum Hydraulic Bond (psi) | | | | | |
|---|---|---|---|---|---|---|
| | | 26% NaCl | 3% | 21% CaCl₂ | | |
| | 3% NaCl | (aqueous) | CaCl₂ | (aqueous) | | |
| Sample | (aqueous) | (10.0 lb/gal) | (aqueous) | (10.0 lb/gal) | Water | Motor Oil |
| Comparative 6 | >50 | — | — | <50 | — | 400 |
| Example 8 | <50 | — | — | <50 | — | 1000 |
| Example 9 | <50 | — | — | <50 | — | 500 |
| Comparative 7 | >50 | >50 | — | >50 | — | 1000+ |
| Example 10 | <50 | <50 | — | <50 | — | 1000 |
| Example 11 | <50 | <50 | — | <50 | — | 700 |
| Comparative 8 | 500 | >50 | >50 | >50 | >50 | <50 |
| Example 12 | 200 | <50 | <50 | <50 | <50 | 300 |
| Example 13 | 700 | <50 | <50 | <50 | <50 | 800 |
| Example 14 | <50 | <50 | <50 | <50 | <50 | 400 |
| Example 15 | <50 | <50 | <50 | <50 | 100 | 200 |
| Example 16 | 200 | <100 | 200 | <50 | 700 | 200 |
| Example 17 | 400 | <50 | 100 | <50 | 300 | 100 |
| Example 18 | 200 | <50 | 200 | <50 | <50 | 300 |
| Example 19 | 100 | <50 | 100 | <50 | 500 | <100 |
| Example 20 | 1000+ | 200 | 800 | 100 | 1000+ | <100 |
| Example 21 | 1000+ | 500 | 1000+ | 200 | 1000+ | 600 |
| Example 22 | 1000+ | 1000 | 600 | 300 | 1000+ | 500 |
| Comparative 9 | <50 | <50 | <50 | <50 | <50 | <50 |
| Example 23 | 700 | 100 | 800 | 600 | <50 | <50 |
| Example 24 | 1000 | 900 | 800 | 100 | 1000+ | 200 |

Motor oil used for the tests is Pure Guard™ SAE ND 30 nondetergent motor oil.

Table 5 shows the hydraulic bond test results performed in a 6-inch pipe following the procedure shown below with commonly encountered well fluids initially filling the pipe. The formulations were placed in the pipe to displace the fluid. All curing, unless otherwise noted, was 3 days at 75° F. and 1 atm.

With respect to Base Composition F, the results showed that when the fluid is motor oil, the addition of sorbitan trioleate (Example 8) and ethoxylated nonylphenol (Example 9) to Base Composition F greatly enhanced the hydraulic bond strength by about 150% and 25%, respectively, relative to the formulation without surfactant (see Comparative 6, Example 8, and Example 9). The addition of a surfactant had little effect on hydraulic bond in the other fluids tested for Base Composition F (see Comparative 6, Example 8, and Example 9). With respect to Base Composition G, the addition of sorbitan trioleate (Example 10) and ethoxylated nonylphenol (Example 11) had either a small effect or reduced the hydraulic bond strength when the fluid is motor oil. In addition, and with respect to Base Composition G, the addition of a surfactant had little effect on hydraulic bond in the other fluids tested (see Comparative 7, Example 10, and Example 11).

Regarding Base Composition H in 3% NaCl (aqueous solution), the addition of ethoxylated nonylphenol (Example 13), Surfactant 13 (Example 20), the combination of Surfactants 1 and 2 with additional mannich base hardener (Example 21), and the combination of 0.1 wt % Surfactant 1 and 0.1 wt % Surfactant 2 (Example 22) greatly enhanced the hydraulic bond strength by about 40%, 100%, 100%, and 100% respectively, relative to the formulation without surfactant (Comparative 8). When the fluid tested was 26% NaCl (aqueous solution), addition of surfactants 1 and 2 (Example 16), Surfactant 13 (Example 20), the combination of Surfactants 1 and 2 and additional mannich base hardener (Example 21), and the addition of 0.1 wt % Surfactant 1 and 0.1 wt % Surfactant 2 (Example 22) greatly enhanced the hydraulic bond strength relative to the formulation without surfactant (Comparative 8) to <100 psi, 200 psi, 500 psi, and 1000 psi, respectively.

When the fluid tested was 3% CaCl₂ (aqueous solution), the addition of the combination of Surfactants 1 and 2 (Example 16), 0.7 wt % Surfactant 2 (Example 17), 0.7 wt % Surfactant 1 (Example 18), and 1 wt % and Surfactant 14 (Example 19) to Base Composition H (Comparative 8) increased the hydraulic bond strength to about 100-200 psi. Surfactant 13 (Example 20), the combination of Surfactants 1 and 2 with additional mannich base hardener (Example 21), and the addition of 0.1 wt % Surfactant 1 and 0.1 wt % Surfactant 2 (Example 22) greatly enhanced the hydraulic bond strength by greater than about 15×, greater than about 19×, and greater than about 11×, respectively, relative to the formulation without surfactant (Comparative 8). Improvements relative to Base Composition H in the hydraulic bond strength were also observed for the addition of Surfactant 13 (Example 20), the combination of Surfactants 1 and 2 with additional mannich base hardener (Example 21), and the addition of 0.1 wt % Surfactant 1 and 0.1 wt % Surfactant 2 (Example 22) in 21% CaCl₂ (aqueous solution).

For the tests performed using water, the addition of Surfactant 12 (Example 15), combination of Surfactants 1 and 2 (Example 16), 0.7 wt % Surfactant 2 (Example 17), and 1 wt % and Surfactant 14 (Example 19) to Base Composition H (Comparative 8) greatly improved the hydraulic strength up to about 500-700 psi. Surfactant 13 (Example 20), the combination of Surfactants 1 and 2 with additional mannich base hardener (Example 21), and the addition of 0.1 wt % Surfactant 1 and 0.1 wt % Surfactant 2 (Example 22) greatly enhanced the hydraulic bond strength by greater than about 19×, relative to the formulation without surfactant (Comparative 8).

For the tests using motor oil, the addition of various surfactants to Base Composition H outperformed the Base Composition H alone. For example, addition of 1 wt % ethoxylated nonylphenol (Example 13), the combination of Surfactants 1 and 2 with additional mannich base hardener (Example 21), and the addition of 0.1 wt % Surfactant 1 and 0.1 wt % Surfactant 2 (Example 22) showed very large improvements in hydraulic bond strength up to about 500-800 psi. Most of the other surfactants added to Base Composition H also increased the hydraulic bond strength to about 100-400 psi (Examples 14-20).

Regarding Base Composition I in 3% NaCl (aqueous solution) (Comparative 9), adding Surfactants 1 and 2 (Example 23), and adding Surfactant 13 (Example 24) greatly enhanced the hydraulic bond strength to about 700 psi and 1000 psi, respectively. When the fluid tested was 26% NaCl (aqueous solution), addition of Surfactants 1 and 2 (Example 23), and adding Surfactant 13 (Example 24) greatly enhanced the hydraulic bond strength relative to the formulation without surfactant (Comparative 8) to about 100 psi and 900 psi, respectively.

When the fluid tested was 3% CaCl₂ (aqueous solution), addition of surfactants improved the hydraulic bond strength of Base composition I to 800 psi (see Comparative 9, Example 23 and Example 24). Improvements relative to Base Composition I were also observed by the addition of surfactants when the fluid tested was 21% CaCl₂ (aqueous solution) (see Comparative 9, Example 23 and Example 24). For the tests performed using water, adding Surfactant 13 (Example 24) to Base Composition I (Comparative 9) greatly enhanced the hydraulic bond strength to greater than 1000 psi. For the tests using motor oil, the addition of Surfactant 13 (Example 24) to Base Composition I outperformed the Base Composition I alone, showing the hydraulic bond strength to increase to 200 psi.

The test results from Tables 3-6 show that the addition of a surfactant advantageously improves the bond strength (both hydraulic and shear bond strengths) of a resin to a pipe in a variety of fluids. The surfactant acts as a bond enhancer.

A seal having improved bond properties (hydraulic bond, shear bond) is set forth herein. The formulation, once set in a pipe or annulus, significantly enhances the bond strength of conventional resins to pipes or annuluses. This improved bond strength increases the durability and stability of the seal. It also improves well integrity, decreases fugitive emissions, and increases barrier performance throughout the lifetime of the well and for after use of the well. The formulation includes a resin, a surfactant, and one or more additives.

### II. Application Example

The formulations can be placed into a well by any method known in the art.

A method of using the resin formulation is provided. In some embodiments, the method of using the resin formulation is a method of treating a wellbore (e.g., a pipe or an annulus). The method of treating a wellbore includes: adding to a wellbore a volume of a resin formulation, the resin formulation comprising a curable resin, a hardener, and a surfactant; and allowing the resin formulation to form a sealant. Adding may be accomplished by, for example, circulation, injection, free fall, or a mechanical delivery device, such as a dump bailer.

In some embodiments, the method includes preparing the resin formulation. Preparing the resin formulation includes mixing the resin formulation by batch mixing or on the fly mixing. For on the fly mixing and in some embodiments, resin, diluent, defoamer, silane, and surfactant are premixed to form a premix. The solids are added to the premix to form a slurry and the slurry is added into the wellbore. Hardener is added into the wellbore.

In some embodiments, the method includes adding a bridge plug and/or fill sand to the wellbore. The operation of adding a bridge plug and/or fill sand to the wellbore may be performed at a location just deeper than an interval at which a permanent seal is desired to establish a temporary base to support resin sealant placed in a well and ensure liquid resin stays in place while hardening. In some embodiments, the method includes applying pressure to the wellbore after addition of the resin formulation to the wellbore. Pressure can be applied by positive displacement pump injecting fluid (e.g., brine) into the well. The application of pressure forces the resin formulation into small spaces of the wellbore and/or into permeable formations of the wellbore.

To seal a well, a resin formulation as detailed herein, is formulated to have appropriate rheology, density, handling time, and mechanical properties under sealant application conditions. The material is then placed into the well by pumping, dump bailing, or gravity displacement with the in situ well fluids, to locate the sealant at the desired sealing location such as a location in the well pipe, annulus, or even an open hole, and allowed to set as a solid and form a barrier to fluid flow therepast.

Alternatively, the resin formulation is formulated and placed as described above adjacent to a permeable formation or an area in the well with a very small hole or holes which has resulted in a pathway for a slow leak of fluids. While the resin formulation is still fluid, differential pressure is applied to force the resin formulation into the permeability or small leak path. The fluid in the leak path or pores in the permeable formation and then hardens along with the resin formulation in the well to form a barrier to fluid flow.

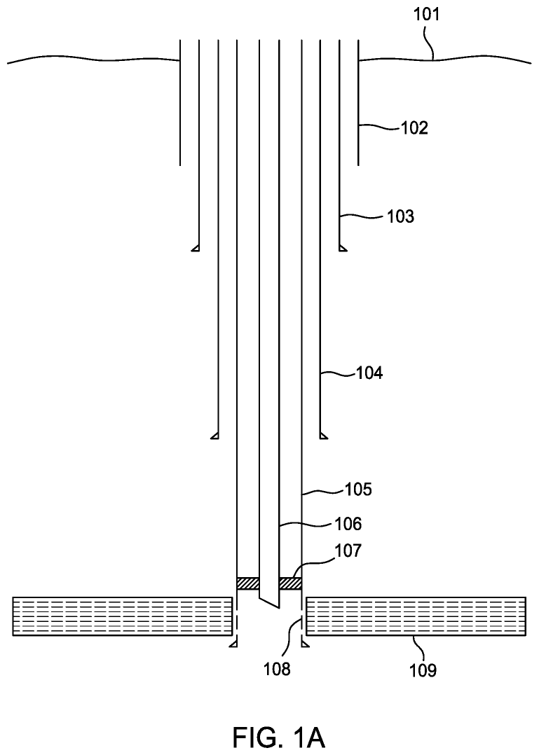

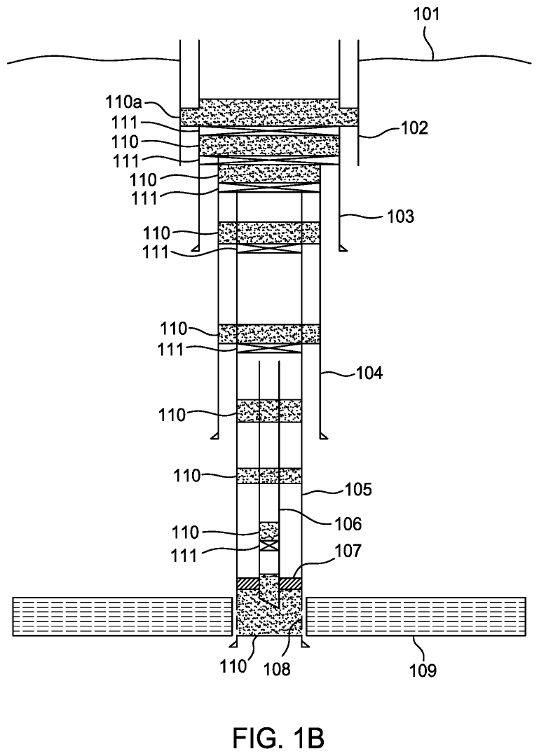

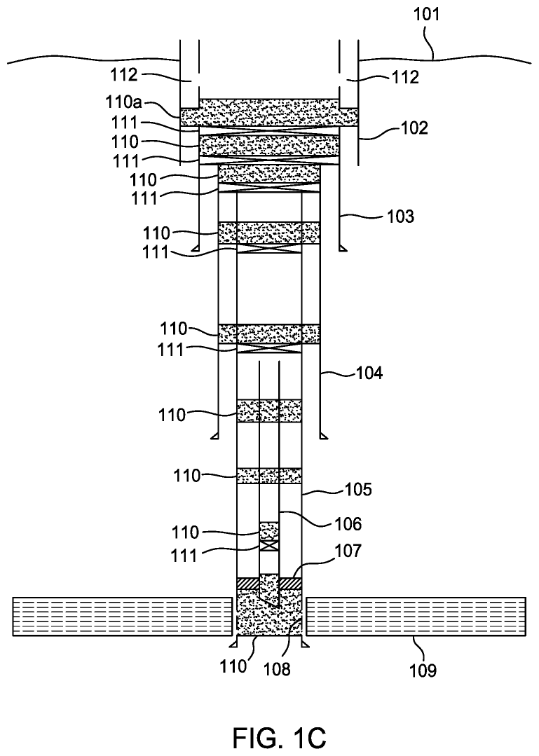

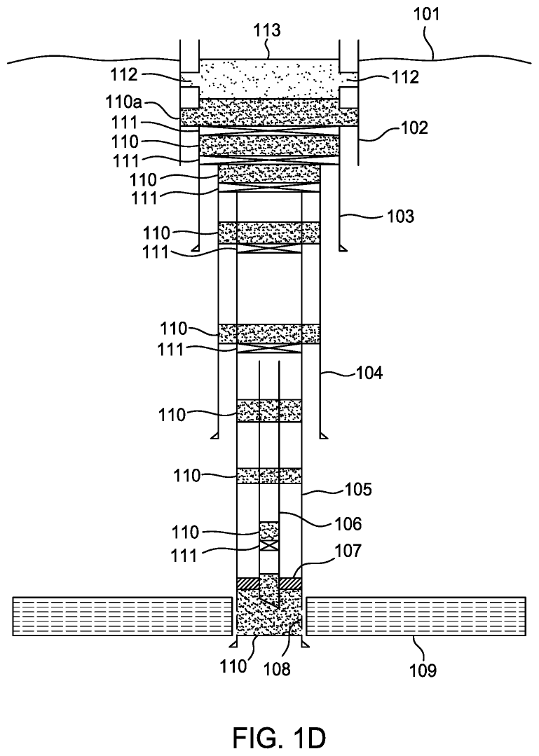

FIGS. 1A-1D illustrate a non-limiting example of treating a well. Methods known in the art for placing sealant can be used and the well may be located on-shore of off-shore.

As shown schematically in FIG. 1A, an offshore well targeted for abandonment includes a plurality of telescoping casings 102 extending from the sea floor 101, or slightly thereabove, to the producing formation 109 inwardly of the earth. The distance between the seafloor and the producing formation(s) is on the order of thousands of feet, whereas the diameter of the casings is on the order of several feet to less than one foot. The series of telescoping casings 102 through 105 were previously cemented in place in the drilled well bore by cement extending between at least portions of the lengths thereof and the adjacent earth formations of the drilled bore, and cement is also located in at least a portion of the annulus where the smaller casing extends inwardly of an overlying larger casing. A production tubing 106 is isolated from the casings by a production packer 107. The casing extending through or into a producing formation includes perforations 108 therethrough to provide a hydrocarbon flow path from the producing formation 109 into the well bore.

FIG. 1B illustrates the same well with normal abandonment operations completed prior to installation of the final plug at the top of the well. At this point in the well abandonment operation, portions of the production tubing 106 and casings 105 and 104 have been cut at locations below the seafloor and removed. A series of mechanical plugs 111 and Portland cement sealant plugs 110 were then placed in casings 102, 103, 104, 105, and 107 and production tube 106. The uppermost plug 110a is subject to strict performance testing to ensure final seal integrity, and thus the overall sealing integrity of the well. For some wells, abandonment is complicated by well seal failures that result in reaching this critical final abandonment step without achieving a seal at the sealing locations deeper in the well and at the uppermost installed sealing location of plug 110a. In this situation, fluid from lower formations in the well will find a pathway up to through the uppermost plug 110a as evidenced by observation of hydrocarbon leakage through the uppermost plug 110a. The presence of a leak at this stage of abandonment is critical since governing agencies will not approve the abandonment if there is leakage at this point, and little room exists to attempt placing more plugs to stop repair the leak. Epoxy resin is often the sealant of choice for this final attempt to plug the well, because the length (height) of an epoxy resin plug having the same sealing properties as a Portland cement seal is significantly shorter than that of the equivalent Portland cement seal. The shorter required sealing plug lengths using epoxy resin will more easily fit into the remaining depth of the well bore and casings 102, 103 adjacent to the top of the well. The diameter of the upper casing ranges from 18 inches to 30 inches, creating the need for a large resin volume to be placed into a cylindrical space with a low surface area to volume ratio. Since well temperatures at these well depths usually range from 65° F. to 80° F., the thermal properties of epoxy resin can result in excessive stress generation in the solid epoxy seal during and after setting and then cooling, and associated seal failure.

FIG. 1C illustrates the well prepared to set an epoxy plug therein above an uppermost plug 110a that has leaked. In this case, a window 112 is milled through the casing 103 and through any cement thereabout to the casing 102 inner wall to allow sealant to flow therein and block any flow paths that might also exist in the annulus between casings 102, 103.

FIG. 1D shows the epoxy seal plug 113 installed above uppermost Portland cement plug 110a in the bore of the casing 103 and extending continuously therefrom into the annulus between casings 102, 103, ultimately into sealing contact with the inner wall of casing 102. The procedure for placement begins with proper formulation, also known in the art as the “design” of the epoxy resin and particulate composition to allow adequate mixing and placement time before setting, to produce a stable, non-settling slurry, and to ensure the resin is mixable with field blenders and pumpable with field pumps. The materials to be intermixed to form the epoxy seal plug 113 are gathered at the work location, mixed and pumped into the well through coiled tubing, jointed tubing, or by a dump bailer to form a column of sealant, in the casing bore and annulus, on the order of 20 to 30 feet in height. The epoxy resin is allowed to set in place and is then tested for seal integrity. Using a seal designed using the factors described herein results in a seal with a high degree of reliability as a result of the sealing material, or the sealed plug formed therewith, developing cracks therein, or pulling away from the adjacent metal of the casing, as a result of the sealing material shrinking after partially or fully hardening.

### Experimental

A. U-Tube Procedure

The U-tube includes a 22-ft long section of 2″ schedule 40 steel pipe (2 inch internal diameter) that was bent into a U-shape with a 1-ft diameter. The vertical sides of the U-tube are approximately 10-ft in length.

Mixing Instructions. The steps for carrying out mixing are generally as follows: A desired amount of base resin, antifoaming agent, diluent, silane, and surfactant were added together in a 3-gallon bucket in the ratios thereof set forth in the Tables for the different formulations. The mixture was then mixed on a drill press equipped with a paint stir paddle at a low rotation speed of about 600 rpm (+/−50 rpm) for about 60 seconds or until the mixture was homogenous. The paint stir paddle used was a 23½-inch long shaft with a 4-inch diameter spiral blade. Weighting agents were then added to the mixture over a time period of about 60 seconds and mixed with a rotation speed of about 600 rpm (+/−50 rpm) for sixty seconds. Hardeners were then added to the mixture over a period of time of about 30 seconds. The mixture was then mixed on the drill press equipped with the paint stir paddle at a low rotation speed of about 600 rpm (+/−50 rpm) for about 20 minutes, which provided the formulation.

General Hydraulic Bond Test Procedure for the U-tube. The U-tube was filled with 1.7 gallons of water. Next, about 1.7 gallons of formulation was added through a funnel into the U-tube, and letting it fall through the pipe on to the water interface, down to the bottom of the U-tube. The resin formulation cured in the U-tube pipe in the air environment under ambient conditions (approximately 75° F. and 0 psi) for 4 about days. The sealant bond to the tube was then evaluated by plumbing up a Teledyne Isco Model 500D Syringe Pump and applying pressure in 50 psi increments up to a maximum of 300 psi. The pressure was maintained for 5-minutes along each increment up to 300 psi. Flowrate was measured by the pump controller real time to evaluate seal at each pressure.

B. 6-Inch Tube Procedure

Mixing instructions. The steps for carrying out mixing are generally as follows: A desired amount of base resin, antifoaming agent, diluent, silane, were added together in a table top mixer (IKA RW 20 stand mixer with equipped with a 4-blade propeller and mixed in a 85-ounce plastic tub) in the ratios thereof set forth in the Tables for the different formulations. This mixture was then mixed for about 60 seconds or until the mixture was homogenous at a low rotation speed of the mixing blade, on the order of 1000 rpm or less (e.g., 600 rpm+/−50 rpm), to induce low shear mixing/intermixing of the components. Weighting agents were then added to the mixture over a time period of about 60 seconds and mixed with a rotation speed of about 600 rpm (+/−50 rpm) for sixty seconds. Hardeners were then added to the mixture over a period of time of about 30 seconds. The mixture was then mixed with a rotation speed of about 600 rpm (+/−50 rpm) for about 5 minutes. Surfactants and K54 (optional) are then added to the mixture, and mixed with a rotation speed of about 600 rpm (+/−50 rpm) for about 1 minute, which provided the formulation used for the 6-inch tube tests.

Hydraulic Bond Measurements. The measurements were performed using a 2 inch internal diameter x 6 inch length schedule 40 water wet pipe. The pipes are configured with a bottom cap to allow for a connection to a Teledyne Isco Model 500D pressure volume (PV) pump. The PV pump applies water pressure in increments of 100 psi until failure of the seal occurs or a maximum pressure reading of 1000 psi occurs.

General Hydraulic Bond Test Procedure for the 6-inch Tube. A PVC cap is placed on one end of a clean, sandblasted 2″ID×6″L Sch. 40 nipple. The cap is secured and sealed. The nipple is filled with water in a bucket. 300 ml of resin formulation is poured into the pipe, letting water displace into the bucket. A high pressure cap is then placed on the open end of the pipe and secured. The resin formulation cured in the pipe for 4 days at 75° F. and 0 psi. The sealant bond was then evaluated by connecting the PV pump to the inlet port located on the high pressure cap, and the PVC cap was removed. Pressure was applied in 100 psi increments until failure of the seal occurs or a maximum pressure reading of 1,000 psi occurs. The pressure was maintained for about 1 minute along each increment up to 1,000 psi. Flowrate was measured by the pump controller real time to evaluate seal at each pressure.

General Shear Bond Test Procedure for the 6-inch Tube. A gasket and PVC cap was placed on one end of a clean, sandblasted 2″ID X 6″L Sch. 40 nipple. The cap is secured and sealed. The nipple is filled with water in a bucket. 100 ml of resin formulation is poured into the pipe, letting water displace into the bucket. The resin formulation cured in the pipe for 4 days room temperature (about 75° F.) at 0 psi. The pipe having the cured resin was placed on a press, and a jig is used to press out the sealant from the pipe. The shear bond is then tested using a Chandler 4207D Compressive Strength Tester using a rate of 4,000 lb/min. The sealant is pressed until failure occurs and the psi needed to break the seal is then calculated. Shear bond calculation is force required to move the plug divided by the surface area of the wetted perimeter.

This shear bond test was conducted to measure how tightly the sealant is bonded to the pipe, and was measured by mechanically forcing the sealant from a small-scale wellbore model. Both water wet and oil wet conditioning of the pipes before curing were tested. The simulated formation/sealant assembly was placed in a press. The sealant and simulated formation was supported while axial load was placed on the sealant with a Chandler model 4207D Compressive Strength Tester until movement was detected between the pipe and sealant. The load at which this movement occurred was divided by the inner pipe area in contact with the sealant to calculate the mechanical shear bond.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

While the foregoing is directed to embodiments of the present invention, other and further embodiments of the invention may be devised without departing from the basic scope thereof, and the scope thereof is determined by the claims that follow.

1-11. (canceled)

12. A method of sealing a subterranean wellbore, comprising:
adding to a subterranean wellbore a volume of a resin formulation, the resin formulation comprising a curable resin, a hardener, and a surfactant, wherein the subterranean wellbore includes a pipe; and
sealing at least a portion of the subterranean wellbore by allowing the resin formulation to set as a solid and form a bond with the pipe.

13. The method of claim 12, wherein the surfactant includes at least one of sorbitan trioleate or ethoxylated nonylphenol.

14. The method of claim 12, wherein the surfactant includes at least one of a combination of an organic acid and a diesel fuel, a combination of a polyamide and a paraffinic solvent, or a combination of sorbitan sesquioleate and ethoxylated sorbitan monooleate.

15. The method of claim 12, wherein the surfactant includes at least one of fatty acids, tall-oil, ethoxylated, octylphenol ethoxylate, ethoxylated fatty alcohol, or sodium alkylnaphthalene-sulfonate.

16. The method of claim 12, wherein the surfactant includes a mixture of alcohols, ethylene glycol, and glycerol.

17. The method of claim 12, wherein the resin formulation further comprises:
a diluent;
a silane; and
a weighting agent.

18. The method of claim 12, wherein the resin formulation further comprises:
micronized rubber.

19. The method of claim 12, further comprising:
adding a bridge plug to the subterranean wellbore at a location just deeper than an interval at which a permanent seal is desired to establish a temporary base to support resin sealant placed in a well and ensure liquid resin stays in place while hardening.

20. The method of claim 12, further comprising:
applying pressure to the subterranean wellbore.

21. The method of claim 12, wherein a concentration of hardener in the resin formulation is from 15 wt % to 80 wt % based on a total weight of the curable resin, and wherein a concentration of surfactant in the resin formulation is from 0.1 wt % to 5 wt % based on the total weight of the curable resin.

22. The method of claim 21, wherein the concentration of surfactant is from 0.25 wt % to 3 wt % based on the total weight of the curable resin.

23. The method of claim 17, wherein a concentration of diluent in the resin formulation is from 5 wt % to 90 wt % based on a total weight of the curable resin, a concentration of silane in the resin formulation is from 0.5 wt % to 20 wt % based on the total weight of the curable resin, and an amount of weighting agent in the resin formulation is such that the resin formulation has a density of from 10.0 lb/gal to 20.0 lb/gal.

24. A method of sealing a subterranean wellbore, comprising:
adding to a subterranean wellbore a volume of a resin formulation, the resin formulation comprising a curable resin, a hardener, a surfactant, a diluent, a silane, and a weighting agent, wherein the subterranean wellbore includes a pipe; and
sealing at least a portion of the subterranean wellbore by allowing the resin formulation to set as a solid and form a bond with the pipe.

25. The method of claim 24, wherein the surfactant includes at least one of sorbitan trioleate or ethoxylated nonylphenol.

26. The method of claim 24, wherein the surfactant includes at least one of a combination of an organic acid and a diesel fuel, a combination of a polyamide and a paraffinic solvent, or a combination of sorbitan sesquioleate and ethoxylated sorbitan monooleate.

27. The method of claim 24, wherein the surfactant includes at least one of fatty acids, tall-oil, ethoxylated, octylphenol ethoxylate, ethoxylated fatty alcohol, or sodium alkylnaphthalene-sulfonate.

28. The method of claim 24, wherein the surfactant includes a mixture of alcohols, ethylene glycol, and glycerol.

29. The method of claim 24, wherein the resin formulation further comprises:
micronized rubber.

30. The method of claim 24, further comprising:
applying pressure to the subterranean wellbore.

31. A method of sealing a subterranean wellbore, comprising:
adding to a subterranean wellbore a volume of a resin formulation, the resin formulation comprising a curable resin, a hardener, a surfactant, a diluent, a silane, and a weighting agent, wherein the subterranean wellbore includes a pipe, and wherein:
a concentration of hardener in the resin formulation is from 15 wt % to 80 wt % based on a total weight of the curable resin,
a concentration of surfactant in the resin formulation is from 0.1 wt % to 5 wt % based on the total weight of the curable resin,
a concentration of diluent in the resin formulation is from 5 wt % to 90 wt % based on the total weight of the curable resin,
a concentration of silane in the resin formulation is from 0.5 wt % to 20 wt % based on the total weight of the curable resin, and
an amount of weighting agent in the resin formulation is such that the resin formulation has a density of from 10.0 lb/gal to 20.0 lb/gal;
applying pressure to the subterranean wellbore; and
sealing at least a portion of the subterranean wellbore by allowing the resin formulation to set as a solid and form a bond with the pipe.
